(19) United States
(12) Patent Application Publication
(10) Pub. No.: US 2026/0030939 A1
(43) Pub. Date: Jan. 29, 2026

(54) METHOD AND SYSTEM FOR DIAGNOSING MOBILITY DEVICE

(71) Applicant: HYUNDAI AUTOEVER CORP., Seoul (KR)

(72) Inventor: Sung Hwan HYUN, Seoul (KR)

(21) Appl. No.: 19/280,816

(22) Filed: Jul. 25, 2025

(30) Foreign Application Priority Data
Jul. 25, 2024 (KR) 10-2024-0098344

(51) Int. Cl. G07C 5/08

(52) U.S. Cl. CPC G07C 5/0808; G07C 5/085

(57) ABSTRACT

Methods and systems for diagnosing mobility devices are described. According to one embodiment, a method of diagnosing a mobility device comprises receiving detailed information of the mobility device to be diagnosed, analyzing the detailed information and determining, based on a result of an analysis of the detailed information, at least one target diagnostic regulation to be applied to the mobility device from among a plurality of candidate diagnostic regulations, and diagnosing a state of the mobility device using the at least one target diagnostic regulation and at least one diagnostic module corresponding to the at least one target diagnostic regulation.

### CROSS-REFERENCE TO RELATED APPLICATION

This application claims priority from Korean Patent Application No. 10-2024-0098344 filed on Jul. 25, 2024 in the Korean Intellectual Property Office, and all the benefits accruing therefrom under 35 U.S.C. 119, the contents of which in its entirety are herein incorporated by reference.

### FIELD

The present disclosure relates to a method and system for diagnosing a mobility device, and more specifically, to an integrated diagnostic method applicable to a diagnostic regulation matching a mobility device from among a plurality of diagnostic regulations, and a system to which the integrated diagnostic method is applied.

### DESCRIPTION OF THE RELATED ART

Diagnostic communication based on the international standard ISO 14229-1, referred to as Unified Diagnostic Services (UDS), is applied to vehicle electronic control units (ECUs) to perform functions such as controlling electronic/electrical devices or outputting fault-related data for internal vehicle management.

In addition, UDS-based On-Board Diagnostics (OBD) includes the SAE-J1979 regulation, which stores, diagnoses, and outputs data related to exhaust emissions and outputs the result, and the SAE-J1979-2 regulation, which is a revised version of SAE-J1979 for eco-friendly vehicles such as electric vehicles.

At this time, all vehicle ECUs must support UDS-based diagnostic communication, and controllers subject to OBD must additionally satisfy the specifications of the SAE-J1979 regulation. Moreover, with the revision of the SAE-J1979 regulation to the SAE-J1979-2 regulation, the application of the revised diagnostic regulation is mandatory for models released in 2027 and beyond.

However, in response to this situation, current vehicle manufacturers are developing and maintaining three different configurations (i.e., UDS, J1979, and J1979-2 specifications) for the same diagnostic communication modules. In other words, maintenance for the UDS specification inevitably requires development and verification efforts for each of the three configurations. For example, methods exist for outputting information that exceeds thresholds.

Accordingly, a technology is needed for diagnosing a vehicle using a diagnostic communication module integrating the three specifications through structural software changes.

### SUMMARY

One objective of the present disclosure is to provide a method and system for diagnosing a mobility device using a single integrated diagnostic communication module to which multiple diagnostic regulations can be applied.

Another objective of the present disclosure is to provide a method and system that can prevent mismatches between controller specifications and diagnostic communication module specifications via software-based specification changes to an integrated diagnostic communication module.

Yet another objective of the present disclosure is to provide a method and system that can reduce the efforts required for maintenance, development, and management of diagnostic communication modules for different specifications.

The objectives of the present disclosure are not limited to those mentioned above, and other objectives not explicitly stated will be clearly understood by those skilled in the art based on the following description.

According to an aspect of the present disclosure, there is provided a method for diagnosing a mobility device, performed by at least one computing device. The method for diagnosing a mobility comprises receiving detailed information of a mobility device to be diagnosed, analyzing the detailed information and determining, based on a result of the analysis, at least one target diagnostic regulation to be applied to the mobility device from among a plurality of candidate diagnostic regulations, and diagnosing a state of the mobility device using the at least one target diagnostic regulation and at least one diagnostic module corresponding to the at least one target diagnostic regulation.

In some embodiments, the mobility device includes a vehicle electronic control unit (ECU) capable of diagnostic communication based on Unified Diagnostic Services (UDS).

In some embodiments, the detailed information of the mobility device includes at least one of exhaust emissions, fuel, manufacturer, or manufacturing date of the mobility device.

In some embodiments, the plurality of candidate diagnostic regulations includes a first diagnostic regulation applicable to a vehicle electronic control unit (ECU) and a second diagnostic regulation applicable to an On Board Diagnostics (OBD) target controller.

In some embodiments, the second diagnostic regulation includes a (2-1)-th diagnostic regulation related to exhaust emissions diagnostics for an internal combustion engine vehicle and a (2-2)-th diagnostic regulation related to exhaust emissions diagnostics for an eco-friendly vehicle.

In some embodiments, the determining of the at least one target diagnostic regulation to be applied to the mobility device includes: determining the first diagnostic regulation as the at least one target diagnostic regulation when the mobility device is identified as a first type based on the result of the analysis.

In some embodiments, the determining of the at least one target diagnostic regulation to be applied to the mobility device includes: determining the first and second diagnostic regulations as the at least one target diagnostic regulation when the mobility device is identified as a second type based on the result of the analysis.

In some embodiments, the at least one diagnostic module outputs a response indicating that a request related to a target diagnostic regulation that is not applicable to the at least one diagnostic module is unprocessable.

In some embodiments, when a request related to a target diagnostic regulation that is not applicable to the at least one diagnostic module is received, the at least one diagnostic module reanalyzes the detailed information of the mobility device and redetermines, based on a result of the reanalysis, the at least one target diagnostic regulation to be applied to the mobility device.

According to an aspect of the present disclosure, there is a system for diagnosing a mobility device, performed by at least one processor, a memory storing at least one computer program executed by the at least one processor, wherein the at least one computer program includes instructions for performing operations of: receiving detailed information of a mobility device to be diagnosed; analyzing the detailed information and determining, based on a result of the analysis, at least one target diagnostic regulation to be applied to the mobility device from among a plurality of candidate diagnostic regulations; and diagnosing a state of the mobility device using the at least one target diagnostic regulation and at least one diagnostic module corresponding to the at least one target diagnostic regulation.

In some embodiments, the mobility device includes a vehicle electronic control unit (ECU) capable of diagnostic communication based on Unified Diagnostic Services (UDS).

In some embodiments, the detailed information of the mobility device includes at least one of exhaust emissions, fuel, manufacturer, or manufacturing date of the mobility device.

In some embodiments, the plurality of candidate diagnostic regulations includes a first diagnostic regulation applicable to a vehicle electronic control unit (ECU) and a second diagnostic regulation applicable to an On Board Diagnostics (OBD) target controller.

In some embodiments, the second diagnostic regulation includes a (2-1)-th diagnostic regulation related to exhaust emissions diagnostics for an internal combustion engine vehicle and a (2-2)-th diagnostic regulation related to exhaust emissions diagnostics for an eco-friendly vehicle.

In some embodiments, the operation of determining the at least one target diagnostic regulation to be applied to the mobility device includes: determining the first diagnostic regulation as the at least one target diagnostic regulation when the mobility device is identified as a first type based on the result of the analysis.

In some embodiments, the operation of determining the at least one target diagnostic regulation to be applied to the mobility device includes: determining the first diagnostic regulation and the second diagnostic regulation as the at least one target diagnostic regulation when the mobility device is identified as a second type based on the result of the analysis.

In some embodiments, the at least one diagnostic module outputs a response indicating that a request related to a target diagnostic regulation that is not applicable to the at least one diagnostic module is unprocessable.

In some embodiments, when a request related to a target diagnostic regulation that is not applicable to the at least one diagnostic module is received, the at least one diagnostic module reanalyzes the detailed information of the mobility device and redetermines, based on a result of the reanalysis, the at least one target diagnostic regulation to be applied to the mobility device.

According to an aspect of the present disclosure, there is computer-readable recording medium storing instructions, wherein the instructions are configured to perform operations of: receiving detailed information of a mobility device to be diagnosed; analyzing the detailed information and determining, based on a result of the analysis, at least one target diagnostic regulation to be applied to the mobility device from among a plurality of candidate diagnostic regulations; and diagnosing a state of the mobility device using the at least one target diagnostic regulation and at least one diagnostic module corresponding to the at least one target diagnostic regulation.

In some embodiments, wherein the mobility device includes a vehicle electronic control unit (ECU) capable of diagnostic communication based on Unified Diagnostic Services (UDS).

According to the aforementioned and other embodiments of the present disclosure, an optimal target diagnostic regulation and sub-diagnostic communication module corresponding to a mobility device may be determined through analysis of detailed information on the mobility device.

In addition, since diagnosis for a plurality of mobility devices is performed using a single integrated diagnostic communication module, user convenience and usability can be improved.

Moreover, even if a diagnostic regulation is revised, development efforts can be reduced because there is no need to develop a new diagnostic communication module corresponding to the revised diagnostic regulation. Maintenance of an integrated diagnostic communication module and configuration management burdens for individual diagnostic modules can also be effectively reduced.

In addition, software-based changes to the specification of the integrated diagnostic communication module can prevent human errors resulting from mismatches with controller specifications.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings:

FIG. 1 is a flowchart illustrating a method for diagnosing a mobility device according to an embodiment of the present disclosure;

FIG. 2 is a diagram illustrating an example of the configuration of a system for diagnosing a mobility device according to an embodiment of the present disclosure;

FIG. 3 is a diagram for explaining some steps illustrated in FIG. 1;

FIG. 4 is a diagram for explaining some steps illustrated in FIG. 3;

FIG. 5 is a diagram for explaining some steps illustrated in FIG. 1; and

FIG. 6 is a block diagram illustrating the hardware configuration of a computing system according to some embodiments of the present disclosure.

### DETAILED DESCRIPTION

Hereinafter, preferred embodiments of the present disclosure will be described with reference to the attached drawings. The advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Prior to the detailed description of the present disclosure, certain terms used herein are clarified for the purposes of clarity and understanding.

In the present disclosure, a mobility device may refer to a means of transportation such as an internal combustion engine vehicle, which is used by people for travel or for transporting goods. Furthermore, the mobility device may be any one of an automobile, locomotive, electric vehicle, autonomous vehicle, bicycle, shared kickboard, or a manned drone, such as Urban Air Mobility (UAM). In addition, the power source used by the mobility device may be an engine, electricity, wind power, or tidal power.

However, for convenience of explanation, the present disclosure assumes that the mobility device is an automobile.

Various embodiments of the present disclosure will hereinafter be described in detail with reference to the accompanying drawings.

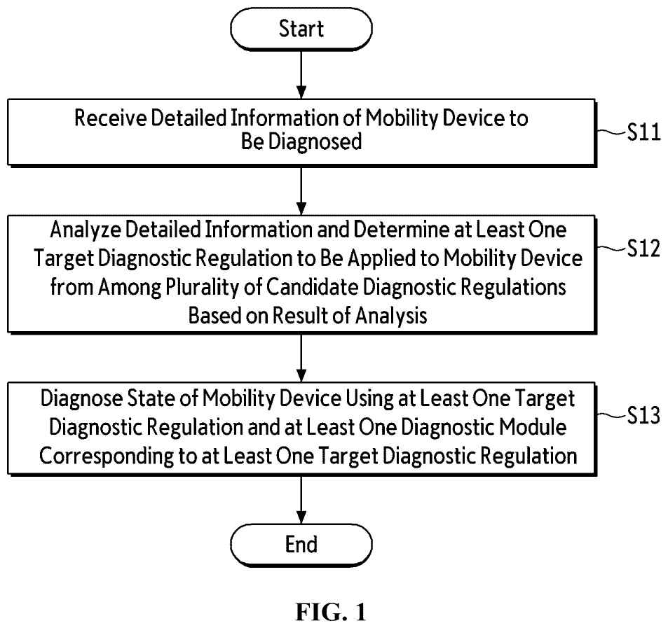

FIG. 1 is a flowchart illustrating a method for diagnosing a mobility device according to an embodiment of the present disclosure. It should be noted that this is merely a preferred embodiment for achieving the objectives of the present disclosure, and certain steps may be added or omitted as needed.

For reference, FIG. 1 illustrates steps/operations of the method for diagnosing a mobility device according to an embodiment of the present disclosure, which are performed by a plurality of modules (e.g., a mobility device detailed information analysis module, a diagnostic regulation analysis module, an integrated diagnostic module, and the like) constituting a mobility device diagnostic system. Accordingly, in the following description, if the subject of a specific step/operation is omitted, it may be understood that the specific step/operation is performed by any one of the modules of the mobility device diagnostic system.

Referring to FIG. 1, the method for diagnosing a mobility device according to an embodiment of the present disclosure may begin with step S11, where the mobility device diagnostic system receives detailed information of a mobility device to be diagnosed. At this time, the mobility device may include a vehicle control electronic device capable of diagnostic communication based on Unified Diagnostic Services (UDS). In addition, the vehicle control electronic device may refer to an electronic control unit (ECU) that controls the state of the mobility device's engine, automatic transmission, anti-lock braking system (ABS), and the like via a computing device.

Furthermore, the detailed information of the mobility device may include at least one piece of information selected from among a plurality of pieces of information on the exhaust emissions (e.g., emission volume, type of emissions, etc.), fuel (e.g., gasoline, electricity, hybrid, etc.), manufacturer, and manufacturing date of the mobility device. The detailed information of the mobility device may be used in the process of determining a target diagnostic regulation applicable to the mobility device from among a plurality of diagnostic regulations that may be referenced during a vehicle diagnostic process.

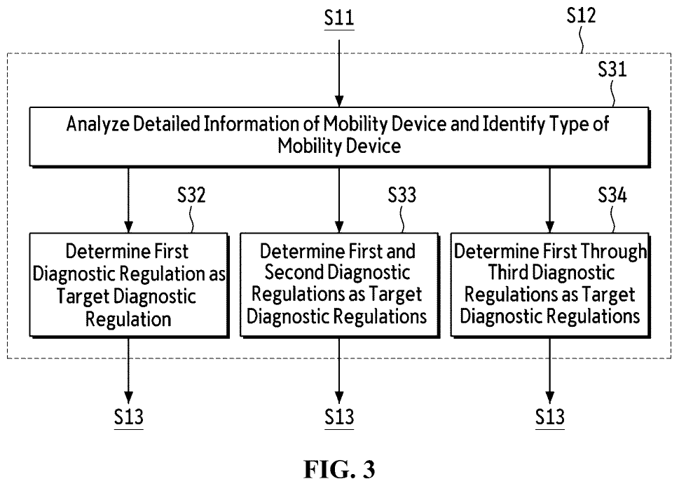

For example, among a plurality of diagnostic regulations related to vehicle diagnostics, the regulations applicable to hybrid vehicles, electric vehicles, and gasoline vehicles may differ from one another, and a diagnostic regulation matching each vehicle may be determined through the analysis of the detailed information of the mobility device (i.e., the vehicle). This will be described later in further detail with reference to FIG. 3 and subsequent drawings.

Referring back to FIG. 1, in step S12, the mobility device diagnostic system may analyze the detailed information of the mobility device received in step S11 and may determine, based on the result of the analysis, at least one target diagnostic regulation to be applied to the mobility device from among a plurality of candidate diagnostic regulations.

Specifically, the analysis of the detailed information of the mobility device may be performed by the detailed information analysis module, and the determining of the at least one target diagnostic regulation to be applied to the mobility device from among the plurality of candidate diagnostic regulations may be performed by the diagnostic regulation determination module. In this case, the detailed information analysis module and the diagnostic regulation determination module may be modules included in the ECU of the vehicle.

In some embodiments, the plurality of candidate diagnostic regulations may include a first diagnostic regulation applicable to vehicle ECUs and a second diagnostic regulation applicable to controllers subject to On-Board Diagnostics (OBD). In this case, the first diagnostic regulation may refer to the UDS protocol defined in the international standard ISO 14229-1, which enables the exchange of standardized messages and commands between various vehicle control units and diagnostic equipment.

In addition, the second diagnostic regulation may include a (2-1)-th diagnostic regulation related to exhaust emissions diagnostics for internal combustion engine vehicles and a (2-2)-th diagnostic regulation related to exhaust emissions diagnostics for eco-friendly vehicles. In this case, the (2-1)-th diagnostic regulation may refer to the SAE-J1979 regulation, and the (2-2)-th diagnostic regulation may refer to the SAE-J1979-2 regulation.

Specifically, the SAE-J1979 regulation may include definitions of error codes that occur in vehicle diagnostic systems and data communication protocols. The SAE-J1979 regulation may define a communication method for diagnosing vehicle status and problems based on the basic protocol of an On-Board Diagnostics II (OBD-II) system. In addition, the SAE-J1979-2 regulation may provide information on diagnostic modules/devices for vehicle diagnostics based on the Controller Area Network (CAN) protocol, and may define standardized operating methods for diagnostic equipment that supports CAN-based communication protocols.

However, the plurality of candidate diagnostic regulations is not limited to the aforementioned examples and may also include various diagnostic regulations that may be differently applied depending on the detailed information of the mobility device.

For example, a third diagnostic regulation may be applied to a mobility device produced during a first period based on its manufacturing date, and a fourth diagnostic regulation may be applied to a mobility device produced during a second period different from the first period. In addition, even for the same internal combustion engine vehicle, a fifth diagnostic regulation may be applied to a vehicle having an engine displacement exceeding a reference level, and a sixth diagnostic regulation may be applied to a vehicle having an engine displacement below the reference level.

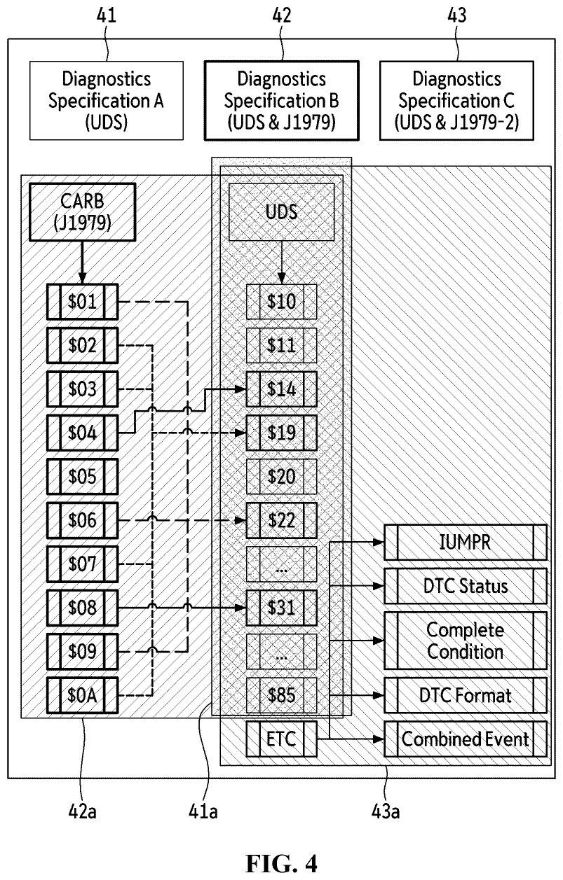

Step S12, where at least one target diagnostic regulation applicable to the mobility device is determined from among the plurality of candidate diagnostic regulations based on the analysis result of the detailed information of the mobility device, will be described later in further detail with reference to FIGS. 3 and 4.

In step S13, the mobility device diagnostic system may diagnose the state of the mobility device using at least one target diagnostic regulation determined in step S12 and at least one diagnostic module corresponding to the determined at least one target diagnostic regulation.

For example, if a first target diagnostic regulation is determined to be applicable to a test target mobility device, the mobility device diagnostic system may diagnose/test the state of the test target mobility device using a first diagnostic module corresponding to the first target diagnostic regulation.

In addition, if both the first target diagnostic regulation and a second target diagnostic regulation are determined to be applicable to the test target mobility device, the mobility device diagnostic system may diagnose/test the state of the test target mobility device using at least one of the first diagnostic module corresponding to the first diagnostic regulation and a second diagnostic module corresponding to the second diagnostic regulation.

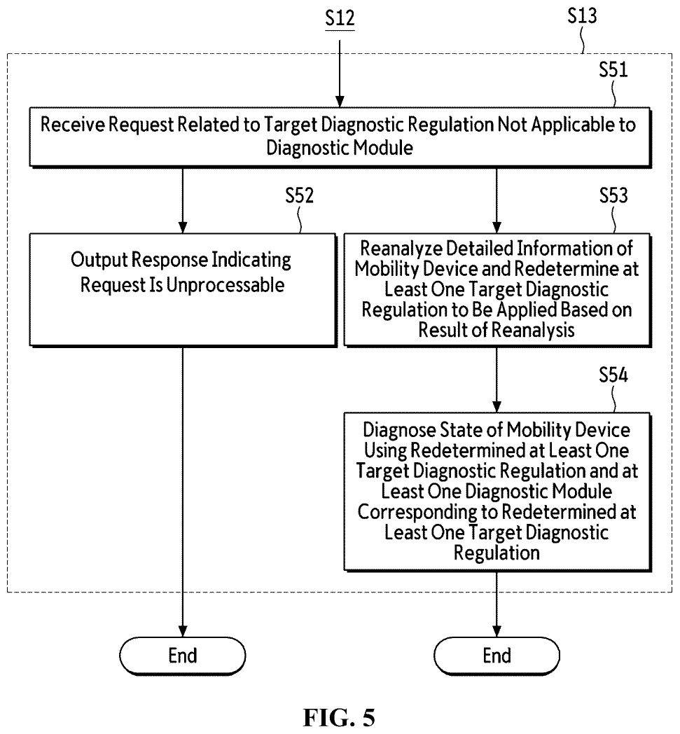

Step S13 will be described later in further detail with reference to FIG. 5.

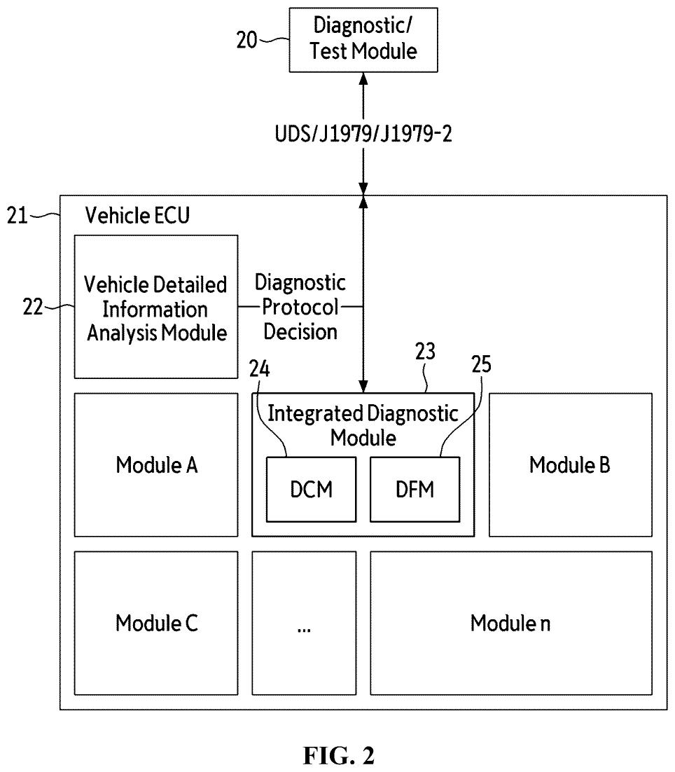

FIG. 2 is a diagram illustrating an example of the configuration of a mobility device diagnostic system according to an embodiment of the present disclosure.

Referring to FIG. 2, a system (hereinafter, the mobility device diagnostic system) for diagnosing a mobility device (e.g., a vehicle) according to an embodiment of the present disclosure may include a diagnostic/test module 20 and a vehicle ECU 21. In this case, the vehicle ECU 21 may include a plurality of modules (e.g., module A and modules B through n) related to vehicle control, including a vehicle detailed information analysis module 22 and an integrated diagnostic module 23. The integrated diagnostic module 23 may include a diagnostic communication manager (DCM) 24 that manages a plurality of services such as UDS services (e.g., “CDTCI, 14h” or “RDTCI, 19h”), services conforming to the SAE-J1979 specification, and services conforming to the SAE-J1979-2 specification, and a diagnostic function manager (DFM) 25 that manages data related to vehicle faults (e.g., fault memory).

When the diagnostic/test module 20 diagnoses/tests a target vehicle, at least one of the plurality of candidate diagnostic regulations (e.g., UDS, J1979, and J1979-2) may be applied depending on the type of the target vehicle. In response to the diagnostic request of the diagnostic/test module 20 for the target vehicle, the vehicle detailed information analysis module 22 of the vehicle ECU 21 may analyze the detailed information of the target vehicle, and the integrated diagnostic module 23 may determine, based on the result of the analysis, at least one target diagnostic regulation to be applied to the target vehicle from among the plurality of candidate diagnostic regulations. Thereafter, the integrated diagnostic module 23 may perform a diagnosis/test on the target vehicle using at least one diagnostic module corresponding to the at least one target diagnostic regulation and may transmit the result of the diagnosis/test to the diagnostic/test module 20.

In short, the mobility device diagnostic system may analyze the detailed information of a mobility device to be diagnosed, determine an optimal target diagnostic regulation corresponding to the mobility device based on the result of the analysis, and perform diagnosis on the mobility device using the optimal target diagnostic regulation and a diagnostic module corresponding to the target diagnostic regulation.

Conventionally, different diagnostic communication modules have existed depending on the specification or type of diagnostic communication regulation for mobility devices, and tests/diagnoses are performed using different diagnostic communication modules for different types of mobility devices. Therefore, there has been a need for the development and production of different diagnostic communication modules depending on the type of mobility device or the type of diagnostic regulation.

In contrast, according to the mobility device diagnostic system of the present disclosure, an optimal target diagnostic regulation and sub-diagnostic communication module corresponding to a mobility device may be determined based on the result of the analysis of detailed information of the mobility device, and thus diagnoses or tests for various types of mobility devices may be performed using a single integrated diagnostic communication module.

Accordingly, since diagnoses for a plurality of mobility devices are performed using a single integrated communication diagnostic module, user convenience and usability can be enhanced. Furthermore, even if a diagnostic regulation is revised, there is no need to develop a new diagnostic communication module corresponding to the revised diagnostic regulation, thereby reducing development efforts. In addition, maintenance of the integrated diagnostic communication module and configuration management burdens for individual diagnostic modules can be effectively reduced.

The process illustrated in FIG. 1 will hereinafter be described in further detail with reference to FIGS. 3 through 5. First, a description of step S12 illustrated in FIG. 1 will be provided with reference to FIGS. 3 and 4.

FIG. 3 is a detailed flowchart for explaining some steps illustrated in FIG. 1. Specifically, FIG. 3 is a detailed flowchart of step S12, which is the step of determining at least one target diagnostic regulation, illustrated in FIG. 1. It should be noted that this is merely a preferred embodiment for achieving the objectives of the present disclosure, and certain steps may be added or omitted as needed.

Referring to FIG. 3, step S12, where the mobility device diagnostic system analyzes detailed information of a mobility device and determines, based on the result of the analysis, at least one target diagnostic regulation to be applied to the mobility device from among a plurality of candidate diagnostic regulations may include step S31, where the detailed information of the mobility device is analyzed to identify the type of the mobility device and steps S32, S33, and S34, where a target diagnostic regulation is determined based on the type of the mobility device.

Specifically, if the mobility device is identified as a first type, a first diagnostic regulation may be determined as a target diagnostic regulation. If the mobility device is identified as a second type, the first diagnostic regulation and a second diagnostic regulation may be determined as target diagnostic regulations. If the mobility device is identified as a third type, the first diagnostic regulation, the second diagnostic regulation, and a third diagnostic regulation may be determined as target diagnostic regulations.

FIG. 4 is a diagram for explaining some steps illustrated in FIG. 3. Specifically, FIG. 4 is a diagram illustrating target diagnostic regulations determined based on the type of the mobility device.

Referring to FIG. 4, a mobility device may be classified into three types, for example, Diagnostics Specification A (41), Diagnostics Specification B (42), and Diagnostics Specification C (43). When the mobility device is classified as the first type (i.e., Diagnostics Specification A), a first diagnostic regulation (e.g., UDS) may be determined as a target diagnostic regulation, and a first service 41a corresponding to the UDS regulation/specification may be set to be usable during a testing/diagnostic process. In addition, when the mobility device is classified as the second type (i.e., Diagnostics Specification B), the first diagnostic regulation (e.g., UDS) and a (2-1)-th diagnostic regulation (e.g., J1979) may be determined as target diagnostic regulations, and a second service 42a corresponding to the UDS and J1979 regulations/specifications may be set to be usable during the testing/diagnostic process. Furthermore, when the mobility device is classified as the third type (i.e., Diagnostics Specification C), a first diagnostic regulation (e.g., UDS) and a (2-2)-th diagnostic regulation (e.g., J1979-2) may be determined as target diagnostic regulations, and a third service 43a corresponding to the UDS and J1979-2 regulations/specifications may be set to be usable during the testing/diagnostic process.

In some embodiments, a response to a Read Out Data service may vary depending on the type of the mobility device (i.e., vehicle) determined through the analysis of the detailed information of the mobility device.

For example, in the first type of vehicle to which the SAE J1979 regulation is applied, responses may be made to CARB $01 and $09 services, and in a second type of vehicle to which the SAE J1979-2 regulation is applied, requested data may be displayed in response to a UDS $22 service. Meanwhile, when the mobility device diagnostic system receives a request for a service that does not correspond to the diagnostic regulation applied to a specific type of target vehicle to be diagnosed/tested, the mobility device diagnostic system may transmit a response to the corresponding diagnostic test module indicating that the request is unprocessable, or may send no response at all.

In addition, the mobility device diagnostic target system may be configured to identify the type of the mobility device and to support only UDS (RDBI, 22h) services for the first type of vehicle (i.e., Diagnostics Specification A) of vehicle and support UDS (RDBI, 22h) and J1979 (CARB 01h, 09h) services for the second type of vehicle (i.e., Diagnostics Specification B). Furthermore, the mobility device diagnostic target system may be configured to support UDS (RDBI, 22h) services for the third type of vehicle (i.e., Diagnostics Specification C) and allow UDS (RDBI, 22h) services to be conducted in place of J1979 (CARB 01h, 09h) services.

In some embodiments, the items for Clear Data, which deletes or initializes diagnostic information under the UDS, SAE J1979, and SAE J1979-2 regulations in an integrated diagnostic communication module, may be configured differently depending on the type of the mobility device (i.e., vehicle) determined based on the analysis of detailed information of the mobility device.

For example, the mobility device diagnostic target system may be configured to identify the type of the mobility device, and support only UDS (CDTCI, 14h) services and support all Diagnostic Trouble Code (DTC) groups for the first type of vehicle (i.e., Diagnostics Specification A). In this case, if the mobility device diagnostic system receives a request for a service that does not correspond to the diagnostic regulation applied to the specific type of target vehicle to be diagnosed/tested, the mobility device diagnostic system may transmit a response indicating that the request is unprocessable to the corresponding diagnostic test module, or may terminate its service without sending any response.

In addition, the mobility device diagnostic target system may be configured to support UDS (CDTCI, 14h) and J1979 (CARB 04h) services for the second type of vehicle (i.e., Diagnostics Specification B). Furthermore, the mobility device diagnostic target system may be configured to support only the UDS (CDTCI, 14h) services, and not the J1979 (CARB 04h) services, for the third type of vehicle (i.e., Diagnostics Specification C). In this case, DTC groups that can be initialized with the UDS (CDTCI, 14h) services may include an All DTCs group and an Emission DTCs group. If the mobility device diagnostic target system receives a request for a DTC group that cannot be initialized, the mobility device diagnostic target system may transmit a response indicating that the request is unprocessable or terminate its service without sending any response.

In some embodiments, a Read Fault Memory item, which displays diagnostic information of the UDS, SAE J1979, and J1979-2 regulations in the integrated diagnostic communication module, may be configured differently depending on the type of the mobility device (i.e., vehicle) determined based on the analysis of detailed information of the mobility device.

For example, the mobility device diagnostic target system may be configured to identify the type of the mobility device, and support only UDS (RDTCI, 19h) services for the first type of vehicle (i.e., Diagnostics Specification A) and support sub-functions required by each type of vehicle. In this case, if the mobility device diagnostic system receives a request for a service that does not correspond to the diagnostic regulation applied to the specific type of target vehicle to be diagnosed/tested, the mobility device diagnostic system may transmit a response indicating that the request is unprocessable to the diagnostic test module, or may terminate its service without sending any response.

Also, the mobility device diagnostic target system may be configured to identify the type of the mobility device and support UDS (RDTCI, 19h) and J1979 (CARB 03h, 07h) services for the second type of vehicle (i.e., Diagnostics Specification B). In this case, the availability of specific sub-functions of the UDS (RDTCI, 19h) services may vary depending on the type of vehicle. Furthermore, the mobility device diagnostic target system may be configured to support only the UDS (RDTCI, 19h) services, and not the J1979 (CARB 03h, 07h) services, for the third type of vehicle (i.e., Diagnostics Specification C).

In short, the mobility device diagnostic system may apply different target diagnostic regulations for different types of mobility devices based on the result of type identification for each mobility device.

Accordingly, since diagnoses/tests for a plurality of mobility devices are performed using the most suitable diagnostic regulations for different types of vehicles via a single integrated communication diagnostic module, user convenience and usability can be enhanced. Furthermore, even if a diagnostic regulation is revised, there is no need to develop a new diagnostic communication module corresponding to the revised diagnostic regulation, thereby reducing development efforts. In addition, maintenance of the integrated diagnostic communication module and configuration management burdens for individual diagnostic modules can be effectively reduced.

FIG. 5 is a diagram for explaining some steps illustrated in FIG. 1. Specifically, FIG. 5 is a detailed flowchart of step S13 in FIG. 1, where the state of a mobility device is diagnosed using at least one target diagnostic regulation and at least one diagnostic module corresponding to the at least one target diagnostic regulation. It should be noted that this is merely a preferred embodiment for achieving the objectives of the present disclosure, and certain steps may be added or omitted as needed.

Referring to FIG. 5, step S13, where the mobility device diagnostic system diagnoses the state of the mobility device using at least one target diagnostic regulation and at least one diagnostic module corresponding to the target diagnostic regulation may include step S51, where a request related to a target diagnostic regulation that is not applicable to the at least one diagnostic module. Specifically, step S51 may be understood as a step in which the mobility device diagnostic system receives a request related to a target diagnostic regulation that cannot be applied to the type of the mobility device identified through the analysis of its detailed information.

In one embodiment, if in step S51, the mobility device diagnostic system receives a processing request for a target diagnostic regulation that cannot be applied to the diagnostic module of the mobility device diagnostic system, in step S52, the mobility device diagnostic system may output a response indicating that the received request is unprocessable. That is, a response indicating that the received request is unprocessable may be sent to the corresponding diagnostic/test device, and the current test/diagnostic procedure or service may be terminated.

In one embodiment, if in step S51, the mobility device diagnostic system receives a processing request for a target diagnostic regulation that cannot be applied to the diagnostic module of the mobility device diagnostic system, in step S53, the mobility device diagnostic system may reanalyze the detailed information of the mobility device and may redetermine at least one target diagnostic regulation to be applied to the mobility device based on the result of the reanalysis. Thereafter, in step S54, the state of the mobility device may be diagnosed using the redetermined at least one target diagnostic regulation and at least one diagnostic module corresponding to the redetermined at least one target diagnostic regulation.

That is, it may be understood that if the received request is determined as not being able to be processed, steps S11 through S13 illustrated in FIG. 1 are performed again for the purpose of verifying whether the detailed analysis of the mobility device has been properly performed.

According to this embodiment, if the mobility device diagnostic system receives a request related to a target diagnostic regulation that cannot be applied to the type of the mobility device, the accuracy of the mobility device diagnostic system can be improved by verifying whether the analysis of the detailed information of the mobility device has been properly performed (i.e., whether the type of the mobility device has been correctly identified).

So far, the method and system for diagnosing a mobility device according to some embodiments of the present disclosure has been described with reference to FIGS. 1 through 5. The mobility device diagnostic system according to some embodiments of the present disclosure may analyze detailed information of a mobility device to be diagnosed, determine an optimal target diagnostic regulation corresponding to the mobility device based on the result of the analysis, and diagnose the mobility device using the target diagnostic regulation and a diagnostic module corresponding to the target diagnostic regulation.

In addition, the mobility device diagnostic system may apply different target diagnostic regulations for different types of mobility device based on the result of mobility device type identification.

Accordingly, since diagnoses/tests for a plurality of mobility devices are performed using the most suitable diagnostic regulations for different types of vehicles via a single integrated communication diagnostic module, user convenience and usability can be enhanced. Furthermore, even if a diagnostic regulation is revised, there is no need to develop a new diagnostic communication module corresponding to the revised diagnostic regulation, thereby reducing development efforts. In addition, maintenance of the integrated diagnostic communication module and configuration management burdens for individual diagnostic modules can be effectively reduced.

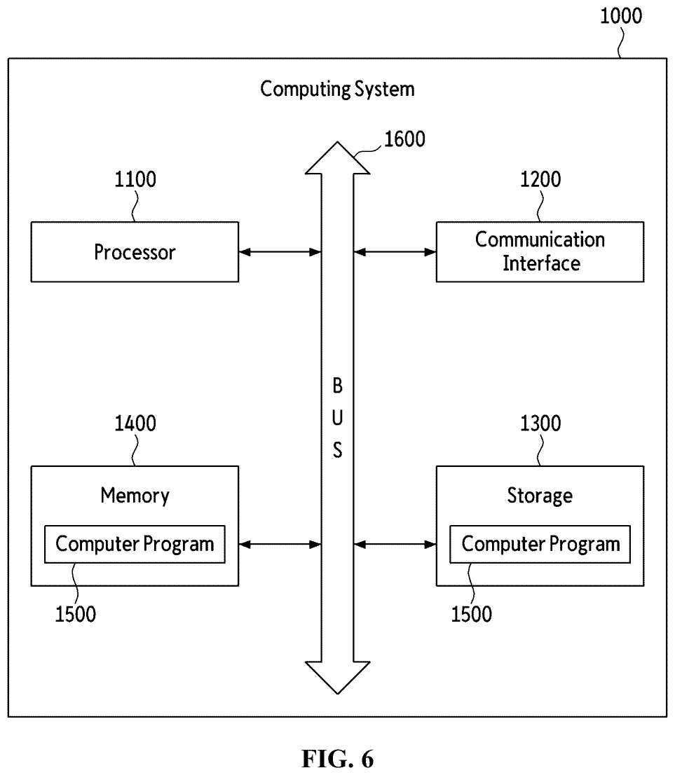

FIG. 6 is a hardware configuration diagram of a computing system according to some embodiments of the present disclosure. Referring to FIG. 6, a computing system 1000 may include at least one processor 1100, a system bus 1600, a communication interface 1200, a memory 1400 that loads a computer program 1500 executed by the processor 1100, and a storage 1300 that stores the computer program 1500.

The processor 1100 controls the overall operation of each component of the computing system 1000. The processor 1100 may perform computations for at least one application or program to execute methods/operations according to various embodiments of the present disclosure. The memory 1400 stores various data, commands, and/or information. The memory 1400 may load one or more computer programs 1500 from the storage 1300 to execute the methods/operations according to various embodiments of the present disclosure. The system bus 1600 provides communication functionality between the components of the computing system 1000. The communication interface 1200 supports Internet communication of the computing system 1000. The storage 1300 may non-transitorily store one or more computer programs 1500. The computer program 1500 may include one or more instructions implementing the methods/operations according to various embodiments of the present disclosure. When the computer program 1500 is loaded into the memory 1400, the processor 1100 may execute the one or more instructions to perform the methods/operations according to various embodiments of the present disclosure.

In some embodiments, the computing system 1000 may be configured using one or more physical servers included in a server farm based on cloud technologies such as virtual machines. In this case, at least some of the processor 1100, the memory 1400, and the storage 1300, among other components illustrated in FIG. 6, may be virtual hardware, and the communication interface 1200 may also be configured as a virtualized networking element such as a virtual switch.

Embodiments of the present disclosure have been described above with reference to FIGS. 1 through 6, but it should be noted that the effects of the present disclosure are not limited to those described above, and other effects of the present disclosure should be apparent from the following description.

The technical features of the present disclosure described so far may be embodied as computer readable codes on a computer readable medium. The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. In concluding the detailed description, those having ordinary skill in the art should appreciate that many variations and modifications can be made to the embodiments without substantially departing from the principles of the present disclosure. Therefore, the disclosed embodiments of the present disclosure are used in a generic and descriptive sense only and not for purposes of limitation. The scope of the present invention is defined by the following claims and their equivalents.

What is claimed is:

1. A method for diagnosing a mobility device, which is performed by at least one computing device, the method comprising:
receiving detailed information of a mobility device to be diagnosed;
analyzing the detailed information and determining, based on a result of an analysis of the detailed information, at least one target diagnostic regulation to be applied to the mobility device from among a plurality of candidate diagnostic regulations; and
diagnosing a state of the mobility device using the at least one target diagnostic regulation and at least one diagnostic module corresponding to the at least one target diagnostic regulation.

2. The method of claim 1, wherein the mobility device includes a vehicle electronic control unit (ECU) capable of diagnostic communication based on Unified Diagnostic Services (UDS).

3. The method of claim 1, wherein the detailed information of the mobility device includes exhaust emissions of the mobility device, a fuel of the mobility device, a manufacturer of the mobility device, or a manufacturing date of the mobility device.

4. The method of claim 1, wherein the plurality of candidate diagnostic regulations includes a first diagnostic regulation applicable to a vehicle ECU and a second diagnostic regulation applicable to an On Board Diagnostics (OBD) target controller.

5. The method of claim 4, wherein the second diagnostic regulation includes a (2-1)-th diagnostic regulation related to exhaust emissions diagnostics for an internal combustion engine vehicle and a (2-2)-th diagnostic regulation related to exhaust emissions diagnostics for an eco-friendly vehicle.

6. The method of claim 4, wherein the determining of the at least one target diagnostic regulation to be applied to the mobility device includes determining the first diagnostic regulation as the at least one target diagnostic regulation when the mobility device is identified as a first type based on the result of the analysis.

7. The method of claim 4, wherein the determining of the at least one target diagnostic regulation to be applied to the mobility device includes determining the first diagnostic regulation and the second diagnostic regulation as the at least one target diagnostic regulation when the mobility device is identified as a second type based on the result of the analysis.

8. The method of claim 1, wherein the at least one diagnostic module outputs a response indicating that a request related to a target diagnostic regulation that is not applicable to the at least one diagnostic module is unprocessable.

9. The method of claim 1, wherein when a request related to a target diagnostic regulation that is not applicable to the at least one diagnostic module is received, the at least one diagnostic module performs a reanalysis of the detailed information of the mobility device and redetermines, based on a result of the reanalysis, the at least one target diagnostic regulation to be applied to the mobility device.

10. A system for diagnosing a mobility device, comprising:
at least one processor; and
a memory storing at least one computer program executed by the at least one processor,
wherein the at least one computer program includes instructions for performing operations of: receiving detailed information of a mobility device to be diagnosed; analyzing the detailed information and determining, based on a result of an analysis of the detailed information, at least one target diagnostic regulation to be applied to the mobility device from among a plurality of candidate diagnostic regulations; and diagnosing a state of the mobility device using the at least one target diagnostic regulation and at least one diagnostic module corresponding to the at least one target diagnostic regulation.

11. The system of claim 10, wherein the mobility device includes a vehicle ECU capable of diagnostic communication based on Unified Diagnostic Services (UDS).

12. The system of claim 10, wherein the detailed information of the mobility device includes exhaust emissions of the mobility device, a fuel of the mobility device, a manufacturer of the mobility device, or a manufacturing date of the mobility device.

13. The system of claim 10, wherein the plurality of candidate diagnostic regulations includes a first diagnostic regulation applicable to an ECU and a second diagnostic regulation applicable to an On Board Diagnostics (OBD) target controller.

14. The system of claim 13, wherein the second diagnostic regulation includes a (2-1)-th diagnostic regulation related to exhaust emissions diagnostics for an internal combustion engine vehicle and a (2-2)-th diagnostic regulation related to exhaust emissions diagnostics for an eco-friendly vehicle.

15. The system of claim 13, wherein the operation of determining the at least one target diagnostic regulation to be applied to the mobility device includes determining the first diagnostic regulation as the at least one target diagnostic regulation when the mobility device is identified as a first type based on the result of the analysis.

16. The system of claim 13, wherein the operation of determining the at least one target diagnostic regulation to be applied to the mobility device includes determining the first diagnostic regulation and the second diagnostic regulation as the at least one target diagnostic regulation when the mobility device is identified as a second type based on the result of the analysis.

17. The system of claim 10, wherein the at least one diagnostic module outputs a response indicating that a request related to a target diagnostic regulation that is not applicable to the at least one diagnostic module is unprocessable.

18. The system of claim 10, wherein when a request related to a target diagnostic regulation that is not applicable to the at least one diagnostic module is received, the at least one diagnostic module performs a reanalysis of the detailed information of the mobility device and redetermines, based on a result of the reanalysis, the at least one target diagnostic regulation to be applied to the mobility device.

19. A non-transitory computer-readable recording medium storing instructions,
wherein the instructions are configured to perform operations of: receiving detailed information of a mobility device to be diagnosed; analyzing the detailed information and determining, based on a result of an analysis of the detailed information, at least one target diagnostic regulation to be applied to the mobility device from among a plurality of candidate diagnostic regulations; and diagnosing a state of the mobility device using the at least one target diagnostic regulation and at least one diagnostic module corresponding to the at least one target diagnostic regulation.

20. The non-transitory computer-readable recording medium of claim 19, wherein the mobility device includes an ECU capable of diagnostic communication based on Unified Diagnostic Services (UDS).
